(19) United States
(12) Patent Application Publication
(10) Pub. No.: US 2003/0146891 A1
(43) Pub. Date: Aug. 7, 2003

(54) Electronic billboard with reflective color liquid crystal displays

(76) Inventor: Ran Poliakine, Motza Ilit (IL)

Correspondence Address: JOHN ALEXANDER GALBREATH, 2516 CHESTNUT WOODS CT, REISTERSTOWN, MD, 21136, US

(21) Appl. No.: 10/343,113

(22) PCT Filed: May 15, 2001
(86) PCT No.: PCT/IL01/00428

(30) Foreign Application Priority Data
May 17, 2000 (IL) 136205

(51) Int. Cl. G09G 3/36

(52) U.S. Cl. 345/87

(57) ABSTRACT

An electronic billboard (EB) system is presented. The system comprises a display device composed of an array of color, reflective, liquid crystal display modules, each including an array of liquid crystals cells, presenting pixels of the display device, and driving circuits selectively operable for displaying a predetermined image by a plurality of said modules; a sensor means; and a control unit for operating said driving circuits, the control unit being responsive to data generated by the sensor means for operating the display device accordingly.

### FIELD OF THE INVENTION

This invention relates to an Electronic Billboard (EB) device formed of a two-dimensional array of color reflective liquid crystal displays.

### BACKGROUND OF THE INVENTION

Indoor and Outdoor Billboards are known display devices widely used all over the world for advertising and other purposes, typically installed in public places where a large number of people can be reached. Most of the conventional billboards utilize printed poster displays. There are some EB's that use Light Emitting Diodes (LED's) Vacuum Fluorescent Displays (VPD's) and Transmissive Liquid Crystal Displays (LCD's). All these displays are based on the light emission effect, which consumes high power and makes them unreadable under bright sunlight conditions.

The present invention utilizes Reflective LCD concept that requires much less power and is highly readable under direct sunlight. electric field. This enables to affect the transmission, scattering, or reflectiity of the light by LC layer enclosed between the parallel sides of a pair of glass plates.

Generally, Electronic Billboards using LCD panels are of two kinds: (1) those utilizing the back illumination of an LC panel and the transmission of an LC material, a so-called “back-lit” transmitting display design; and (2) those utilizing ambient lighting conditions and transmission or reflectivity of the LC material a so-called “front-lit” reflective display design.

One of the “front-lit” designs is based on naturally reflective properties of cholesteric (chiral nematic) liquid crystals. LCD panels based on this technology provide full image retention with low power and excellent daylight/ambient light readability, and therefore are supposed to be more suitable for low power hand held applications such as cell phones, pagers, etc.

More specifically, in such a reflective LCD panel layers of LC molecules can be parallel to the plane of the display (a so-called “planar state”) or be randomly aligned (a so-called “focal conic state”). When in the planar state of the LC molecules, the display panel provides a brightly colored appearance, a so-called “bright-on” state, while the focal conic state of the molecules provides a virtually clear view of a back cell background, so-called “dark-off” state. By the application of a suitable electric field, the LC material can be switched between these two states. In other words, the planar and focal conic states are two “zero-field” stable states of the LC layer.

To ensure the time stability of the focal conic “off” states, it is known to use an optimal alignment layer such as a homeotropic polymide alignment layer, as disclosed in the article “Surface Stabilized Cholesteric Texture Displays”, Merck Ltd., Mar. 27, 1998. As specifically indicated in this article, the alignment material also affects a range of gray scales, and to give the desired performance of LCD panel, such a parameter as alignment layer material should be optimized.

U.S. Pat. No. 4,923,286 discloses a display cell of the kind specified. This LC cell utilizes one alignment layer that induces a planar (homogeneous) alignment of the LC molecules and another alignment layer that induces a hemeotropic alignment of the molecules. The LC cell operates at low power, and provides a very good contrast. The planar alignment layer is made of rubbed polyimide.

U.S. Pat. No. 5,880,801 discloses a hybrid aligned liquid crystal display employing an anodized alignment layer. According to this technique, a liquid crystal material is capsulated between top and bottom substrates, which induce homogeneous and homeotropic alignment, respectively, of a liquid crystal.

Both the “back-lit” and the “front-lit” techniques are problematic when dealing with LCD panels of a large size, because it is difficult to maintain large glass plates exactly parallel to each other when fastening them (e.g. gluing) at opposite sides. U.S. Pat. No. 5,805,117 discloses a large area tiled flat-panel modular display system, utilizing the principles of the “back-lit” technique. This display system includes an array of display modules containing thin seal LCDs. Global light sources are used for providing efficient uniform backlighting of the alignment of the display modules.

Additionally, it is a common goal of all display systems to provide as high as possible gray level range. For this purpose, it is known to use a sub-pixel technique, according to which each pixel is divided into a plurality of separately operated sub-pixel elements. This technique is disclosed, for example, in U.S. Pat. No. 4,840,460. However, this and other known sub-pixel techniques always divide a pixel into identical sub-pixels aligned in a regular array, thereby limiting the effective gray level scale.

Additionally, it would be desirable to have such a display device, where at least a part of the display can be independently operated without impeding a concurrent operation of the remaining part of the display. This enables various visual effects to be provided in accordance with a specific application, for example that associated with advertisement in public places.

### SUMMARY OF THE INVENTION

There is accordingly a need in the art to improve Electronic Billboard systems by providing a novel LCD-based system utilizing the principles of the “front-lit” reflective technique, particularly for outdoor advertising.

It is a major feature of embodiments of the present invention to provide such an EB system that utilizes a color reflective LCD display panel, and preferably enabling substantially proximate remote control of the billboard operation (pixel activation management). Furthermore, remote control enabling of content is facilitated using ordinary telephone communications, cellular telephone communications, other wireless communications, satellite download, etc; wherein is performed transmissions of data content, for buffers that are then represented as pixels on the respective display modules, for instructions for performing image transition effects between a current image and a next image, etc.

The Color Reflective LCD's can use large variety of LC materials, such as Twisted Nematic (TN), Super-Twisted Nematic (STN), Polymer-Dispersed (PDLC), Ferro-Electric, and Cholesteric types. More specifically, the Cholesteric LCD's can be Polymer Stabilized Cholesteric Texture (PSCT) types, and Surface Stabilized Cholesteric Texture SSCT.

The SSCT technology is based on the naturally reflective properties of the Cholesteric (chiral nematic) liquid crystals. The displays based on SSCT liquid crystals have full image retention with no power applied, excellent readability, good display addressing, and potential for obtaining display colors. Chiral nematic liquid crystals are characterized by an internal helical layered structure that reflects incident light in a narrow wavelength band. The central wavelength of the reflected light depends on the average pitch of a helical structure and on the average refractive index of a liquid crystal material according to the Bragg Law. Spectral bandwidth of the reflected light depends on the birefringence of the liquid crystal material. The spectral bandwidth and reflection intensity also depend on the disorientation of the helical axes. For available cholesteric liquid crystals, the reflection bandwidth of 100-150 nm has been achieved.

Since the reflected light is circularly polarized, only half of the light intensity is reflected and the other half is transmitted. Therefore, the maximum theoretical reflected intensity from a single cell display is 50% in a narrow spectral bandwidth. In practice, due to variation in the orientation of liquid crystal molecules and other factors, the obtained reflectance is in the order of 20-30%.

In practice, helical pitch of the Cholesteric liquid crystal can be modified by addition of the nematic component. Thus, cholesteric mixtures that reflect light in the Red, Green and Blue spectral regions (or the likes) could be prepared. By using stacked cells filled with SSCT material of opposite twist and with helical pitch corresponding to the primary Red, Green, and Blue colors, the multicolor displays can be produced with total white light reflectivity of about 40-50%. The display color quality can be optimized by using specially developed alignment layers, addition of dies, or by varying the LCD compositions. RGB pixels can be aligned in a common plane or in a triple stack or according to other topological relations wherein the relations are substantially modeled in a data structure of electronic control circuitry that facilitates the activation or deactivation of each specific pixel component (the R, the G, the B, etc.).

It is a further feature of an embodiment of the present invention to provide such an EB system that is capable of displaying real-time on-line images, such as hot news (news-flashes), police, traffic, weather, political, sport, etc, information.

It is a further feature of another embodiment of the present invention to provide such an EB that enables high contrast of displayed information.

The main idea of the present invention is based on the following. Large Billboards, which are to be accommodated in popular city locations where a large number of people can be reached, such as busy streets, squares, shopping malls, large shops, sports stadiums, tourist centers, etc., have much stronger requirements for time and space sharing and a high flexibility of computer controlled electronic advertising, than the resolution of the displayed image defined by the pixel size. To meet the most important requirements of a large Billboard, a reflective color LCD display according to the present invention is designed in a modular manner enabling separate operation of each module. This modular design allows for desirably varying the number of LCD modules and their arrangement in accordance with the requirement for EB size and placement Since the EB is intended to be viewed at a distance of more than 10 meters, gaps between the adjacent LCD modules will not significantly affect the image quality. The use of a color reflective-type LCD modules enables direct sunlight readability in outdoor placement. As for the dark hours and night periods, the display device is illuminated from the front, like a typical poster billboard. Additionally, the remote operation of the EB device is carried out by a two-way communication technique. To this end, the EB device itself is provided with a suitable sensing data processing and transmitting means.

There is thus provided according to one aspect of the present invention, an electronic billboard (EB) system including:

a color reflecting display device composed of an array of color, reflective, liquid crystal display modules, each including an array of liquid crystals cells, presenting pixels of the display device, and driving circuits selectively operable for displaying a predetermined image by a plurality of said modules;

a sensor means; and

a control unit operating the driving circuits of the display device for displaying said predetermined image, the control unit being responsive to data generated by the sensor means for operating the display device accordingly.

The driving circuits of the reflective color LCD module comprise an electrical means for applying a certain electric field to the liquid crystal cells (pixels) to shift between their inoperative and operative positions. Preferably, the liquid crystal display modules are provided with cooling and heating means, while the sensor means comprises a temperature sensor. The control unit, in response to the data generated by the temperature sensors, operates the heating or cooling means to provide compensation for temperature variations between the modules.

The EB system preferably also comprises an eternal illumination system, which may be selectively operated by the control unit, when required. To this end, the sensor means comprises an illumination sensor detecting the level of ambient light in the vicinity of the display device.

Preferably, the sensor means comprises a sensor capable of determining a certain condition of environment in the vicinity of the display device, generating data indicative thereof and transmitting this data to the control unit. This enables to display relevant information associated with the detected condition. For example, such means may include an imaging means (e.g., a video camera) for observing the surroundings of the display device, temperature sensor, humidity sensor, acoustic sensor, etc. To this end, the preferred embodiment of the control unit represents a so-called “expert system”, and is based on so-called “neural networks like algorithms” or another similar model for artificial intelligence decision making. For example, if the camera-like sensor captures an image indicative of a traffic jam, the control unit in response to this data immediately operates the display device to display vehicle related advertising information, e.g., vehicle accessories. If the humidity sensor detects the existence of rain and generates data indicative thereof, the control unit may decide to display umbrella-related advertising information. If the temperature and/or lighting sensor detects the high temperature and high sunshine conditions within the vicinity of the display device, the display device is immediately operated by the control unit to advertise sunglasses and/or beverages.

Thus, the same control unit or an additional one may be remotely located and wirelessly coupled to the display device, so as to operate the device for displaying real-time, on-line images, and is also capable of recording the displayed information. In other words, the device may be preprogrammed for sequentially displaying certain data, and be additionally operated for displaying other, incidentally relevant information.

The control unit may be connectable to the INTERNET, so as to be responsive to the “hottest” news for operating the display accordingly to display the relevant information.

Liquid crystal cells each presenting a pixel of the display module are of a reflective type, and may utilize any suitable LC material of TN, STN, PDLC, PSCT, SSCT or ferroelectric type. Preferably, the display device is capable of displaying colored pictures. This can be achieved by means of dies, filters or LCD compositions. RGB pixels can be aligned in a common plane or in a triple stack.

Preferably, the liquid crystal material used is of a SSCT type, and the application of AC bias during the device operation is used for improving the contrast of the display device. More specifically, AC bias is applied to the LC cell when in an inoperative position of the device to maintain the liquid crystal in its “transmitting” state, i.e., when the LC molecules are substantially perpendicular to a background plane. Additionally, to improve the reflectance of the device, an alignment layer used in LC cells can be optimized for providing maximal reflectance when in a planar state, i.e., substantially parallel to the background plane.

To increase gray levels of the displayed image, either voltage values and/or voltage application time are controlled by the control unit, or each pixel (LC cell) is subdivided to a predetermined number of sub-pixels. Preferably, the sub-pixel subdivision is irregular, thus enabling more uniform color to be obtained across the pixel.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic illustration of a EB system utilizing an LCD modules according to one embodiment of the invention;

FIG. 2 more specifically illustrates the LCD module of the EB of FIG. 1;

FIG. 3 illustrates one possible example of assembling the LCD modules in the system of FIG. 1;

FIG. 4a illustrates more specifically a metal plate used for mounting the LCD module thereon;

FIG. 4b illustrates the multi-stack LCD module an metal plate with flexible connectors mounted on the metal plate of FIG. 4a;

FIGS. 5a and 5b illustrate two possible examples, respectively, of RGB sub-pixels arrangement utilizing the color patterning configuration;

FIG. 6 there is illustrated an LCD module utilizing a triple RGB stack configuration;

FIG. 7 illustrates the main principles of double twisted effect suitable to be used in the LCD module to increase its reflectance;

FIGS. 8a and 8b show two different LCD modules, respectively, utilizing the double twisted effect of FIG. 7; and

FIG. 9 is a block diagram of some elements of the system of FIG. 1, more specifically illustrating some more features of the present invention.

### DETAILED DESCRIPTION OF THE INVENTION

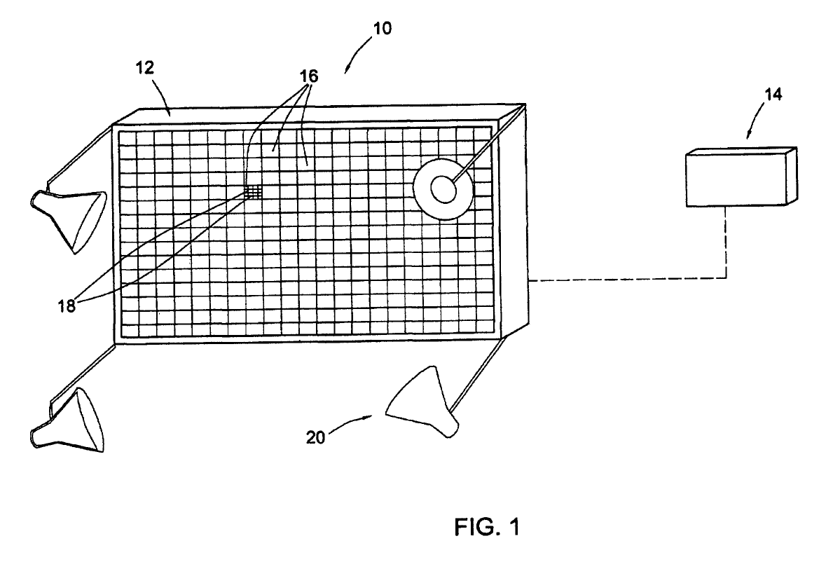

Referring to FIG. 1, there is illustrated an EB system, generally designated 10, constructed according to the invention. The system 10 comprises such main constructional parts as an electronic billboard frame (constituting a display device) 12 and a control unit 14 which, according to the present example, is wireless connected to communication ports (not shown) of the display device 12.

The display device 12 comprises a two-dimensional array of color, reflective LCD modules 16. As partly shown in the figure, each LCD module 16 is composed of a two-dimensional array of LC cells, generally at 18, each presenting a pixel of the display device. The LC cell 18 typically includes a layer of LC material enclosed between two glass plates covered with patterned transparent conductive electrodes made of Indium Tin Oxide (ITO), and an alignment layer at inner surface of each of the glass plates. Here, the LC material is of a color reflective type utilizing a Surface Stabilized Cholesteric Texture (SSCT) technology. This technology is preferred for such applications where high resolution is not needed, and is advantageously characterized by high sunlight readability, sufficiently good contrast, a large viewing angle and gray level capability. The SSCT technology does not require active driving, backlighting and polarizers, and uses relatively simple manufacturing procedures that allow high yields and low manufacturing costs. Generally, any other reflective LC material can be used, such as TN, STN, PDLC, PSCT or a ferroelectric type.

The operational principles of the reflective LC cell are known per se and therefore need not be specifically described, except to note the following. Reflective LC molecules, when in a substantially planar state (i.e., being oriented substantially parallel to the glass plates), reflect incident light, and when being oriented substantially perpendicular to the glass plates, transmit incident light, thereby exposing a background plane for view. According to the present invention, in both operative and inoperative positions of a specific LC cell, the corresponding LC molecules are maintained in their planar or perpendicular state, respectively, by applying appropriate AC bias, e.g., 10-80V, rather than utilizing the bi-stability of the LC material. This provides for better contrast of the displayed image.

Further provided in the system 10 is an external illumination system 20 mounted on display device 12. In the present example of FIG. 1, the illumination system 20 is in the form of four lamps located in the corners of the billboard. The lamps 20 are selectively operated by the control unit 14 in accordance with the level of ambient light in the vicinity of the display device. To this end, the display device 12 comprises a suitable illumination sensor capable of detecting the level of ambient light, generating data indicative thereof and transmitting this data to the control unit 14. Alternatively, or additionally, the control unit may be preprogrammed to switch on the lamps 20 at night periods.

It should be noted, although not specifically shown, that an additional suitable processor integral with the display device could be used for operating the lamps 20, rather than using the remote control unit 14. Obviously, the control unit 14 itself could be an integral part of the display device 12, rather than being a stand-alone unit, or some utilities of the control unit could be installed in the display device, while the others be remotely accommodated. The control unit 14 is typically a computer device having suitable hardware and software to operate as an “expert system” capable of artificial intelligence decision making, as will be described more specifically further below. It should be noted, although not specifically shown, that the lamps 20 may be elongated, extending along the sides of the billboard frame 12.

The display device 12 is designed to be viewed from a minimal distance of 10 meters. For example, the billboard may have 320×240 pixels (LC cells), thereby providing a ¼ VGA resolution that allows for using the existing computer programs and hardware, while achieving sufficient image quality. It should be understood that the size of the individual LCD module 16 is determined by the manufacturing capability. The number of the LCD modules 16 and their arrangement are defined by the requirements of a specific application. Taking into account the human eye resolution (spherical angle of about 1minute), the optimal pixel size will depend on the average viewing distance. For a given pixel size, if the viewing distance is too small the artifacts will be seen and the image will not be assessed as whole, while at a too large viewing distance the eye will see several pixels as one point and fine details will be lost. For an average distance of 35 meters, which is typical for the urban environment, the optimal pixel size should be 10 mm×10 mm.

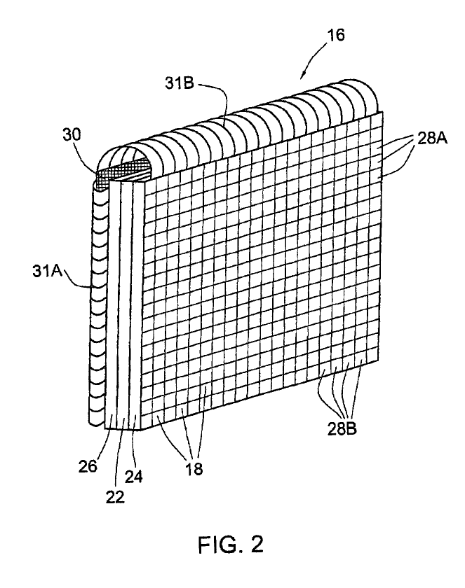

Reference is now made to FIG. 2, more specifically illustrating the construction of the LCD module 16. The LCD module is formed by a layer 22 of the color reflective LC material (SSCT in the present example) enclosed between a front transparent plate 24 and a back transparent plate 26. The LC cells 18 are arranged in rows 28a and columns 28b. Each LC cell 18 has its related driving circuits accommodated within an electronics-containing layer 30 behind the back glass plate 26. Flexible connectors 31a and 31b connect the LC cells' rows and columns, respectively, to the corresponding driving circuits. Thus, the control unit operates each LC cell (pixel) via the electronics in the layer 30 to shift the corresponding LC molecules between their planar and perpendicular orientation.

It should be noted, although not specifically shown, that the layer 30 contains all electronic circuits including the following: power supply, drivers, processor and memory utilities, communication interface (input and output communication ports). It is important to note that this electronics-containing layer also comprises temperature sensors with compensation circuits, and heating/cooling means coupled to the compensation circuits. As indicated above, the electronics contained in the layer 30 (i.e., integral with the display device) may also include a driver of the external illumination system (i.e. light source 20 in FIG. 1). Additionally, the entire electronics also includes a sensor means for monitoring surrounding area and display appearance. Such sensor means may include a video camera, a temperature sensor, a humidity sensor, an acoustic sensor, etc. D generated by one or several different sensors is transmitted to the control unit 14, which, in response to the received data, operates the display device to display information relevant to the detected conditions in the vicinity of the display device.

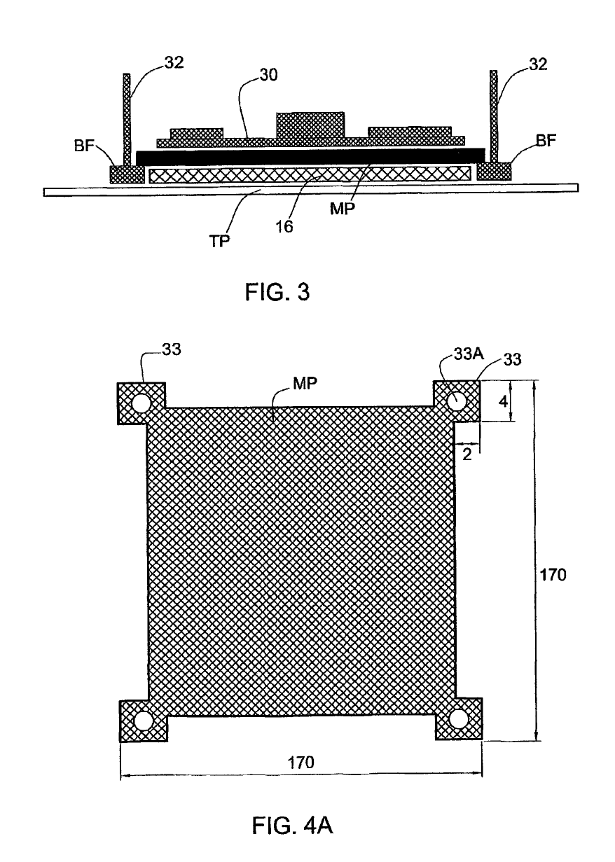

The entire billboard composed of a plurality of LCD modules can be assembled by any suitable technique. FIG. 3 illustrates one possible example of assembling the LCD modules 16. The LCD module 16 made of glass is mounted on a metal plate MP (e.g., made of aluminum). A common, replaceable transparent plate TP, for example, a polycarbonate cover with a special coating absorbing solar UV radiation, covers all the LCD modules (only one such module being shown in the figure). The layer 30 presenting a printed circuit board (PCB) with electronics and driving circuits is accommodated behind the metal plate MP. Thus, all the electrical connectors are on the backside of the module 16. The display modules are easily interchangeable for repairs and replacement. A hermetically sealed billboard frame BF formed with pin-like elements 32 supports the stacked structures of the LCD modules 16.

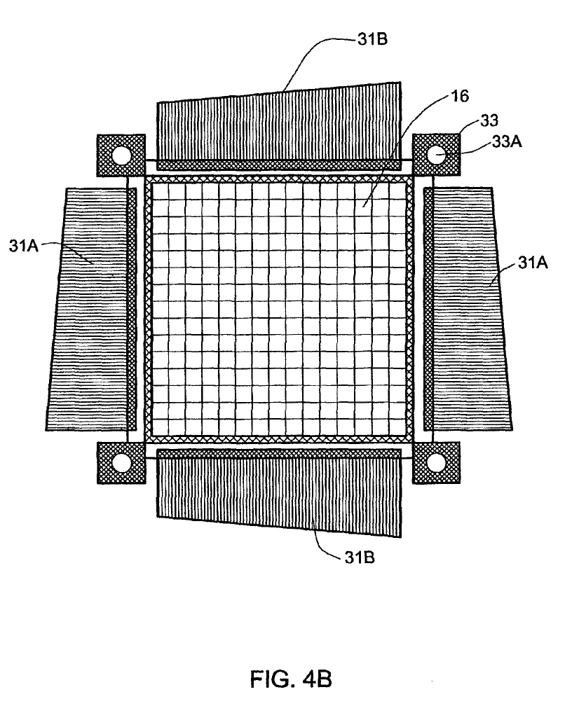

FIG. 4a illustrates more specifically the metal plate MP formed with four projections 33 at the corners of the plate. Each projection 33 is formed with an opening 33a for in the pin-like elements 32 therein. FIG. 4b illustrates the LCD module 16 with the flexible connectors 31a and 31b mounted on the metal plate MP.

It should be noted, although not specifically shown, that the gaps between two adjacent LCD modules 16 mounted on the metal plate are screened by a black mask, and are in the order of 5 mm. The depth of the billboard constructed as described above is in the order of 10-40 cm. As for the overall size of the billboard having 320×240 pixels with a 10 mm×10 mm pixel-size, taking into account the gaps between the LCD modules and edges occupies by glue area, it will be on the order of 340×260 cm. It should, however, be noted that this is just a specific example of a small prototype EB. As for the commercial EB, the overall pixel size can be from 5 mm×5 mm to 30 mm×30 mm. The number of pixels per module will be determined by the module size (up to 30 cm×40 cm), and the number of modules per EB (and thus an overall number of pixels) will be determined by the EB size and shape that can be very small or very large (e.g., 10 m×20 m) depending on the placement parameters and billboard cost.

The LCD module 16 can be fabricated by any known suitable technique. The currently used manufacturing technique utilizes glued glass substrates with spacers between them being filled with LC liquid using vacuum filling. Another known technique is based on a heat press adhesive process. According to this technique, the LC layer is enclosed between two plastic film substrates. Resin supports made of hot melt materials are formed regularly on one plastic substrate using a screen printing method, and spacers that control the cell gap are spayed on the other substrate. The supports are formed taller than the cell gap. Then, the both substrates are stacked on with the liquid crystal materials between them. Finally, heat and pressure are applied to the structure, resin supports are modified to be flat and stuck both substrates together. This fabrication method requires no vacuum filing process, and is easy enough to be used for fabricating large displays. This method is suitable not only for cholesteric LCDs but any other LCDs. This technique is disclosed in the article “Reflective Color Display Using Cholesteric Liquid Crystals”, K. Hashimoto et al., SID 98 DIGEST, pp. 897-900.

The resulting billboard optical parameters depend on the selected LCD technology. The main factors defining the optical quality include the following: color, reflectance, contrast and billboard electronics.

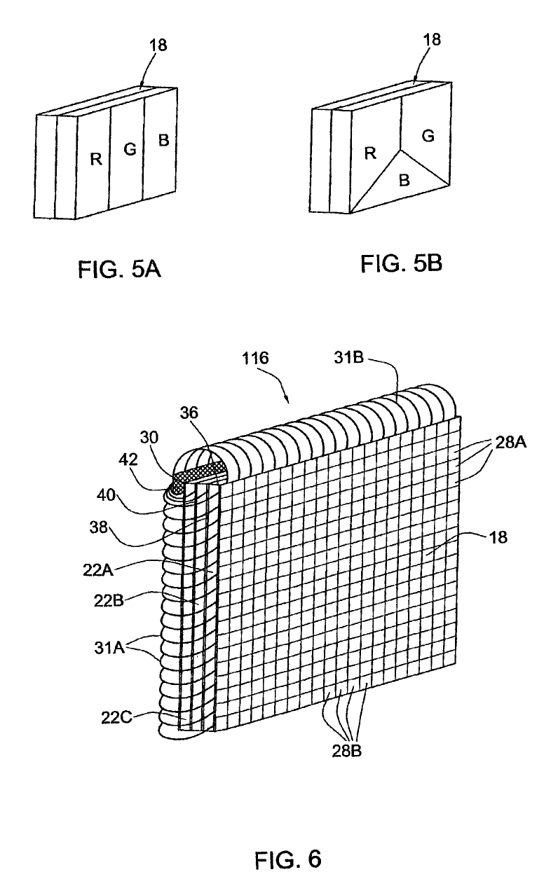

With regard to color, full color (RGB) is required for each pixel. In the above-described example, the color LC cell 18, or a single pixel unit, has a one-layer structure, that is RGB sub-pixels are aligned in a common plane by means of so-called color patterning. Two possible examples of the RGB sub-pixels arrangement are illustrated in FIGS. 5a and 5b in a self-explanatory manner.

Turning now to FIG. 6, there is illustrated an LCD module 116 utilizing a triple RGB stack. The same reference numbers identify those components, which are common in the modules 16 and 116. Here, three LC layers 22a, 22b and 22c are shown, corresponding respectively, to three primary colors—red, green and blue. Transparent layers 36, 38, 40 and 42 serve for enclosing each of the LC layers between two adjacent layers. The above-described technique, based on the heat press adhesive process, is suitable for the manufacture of the LCD module 116. It should, however, be noted that any other technique can be used, for example, those disclosed in the following articles: “Eight-Color High-Resolution Reflective Cholesteric LCDs”, D. Davis et al., SID 98 DIGEST, pp. 901-904; and “Full Color (4096 Colors) Reflective Cholesteric Liquid Crystal Display”, X. Y. Huang et al., ASIA DISPLAY 98, pp. 883-886.

The display driving provides a suitable number of gray levels that enables to obtain large number of colors. For each color, the multiple gray levels could be obtained by controlling voltages, duly cycle or by dithering, e.g. by subdividing each pixel to four sub-pixels with an area ratio of 1:2:4:8. The sub-pixel subdivision is feasible here because of the large pixel size.

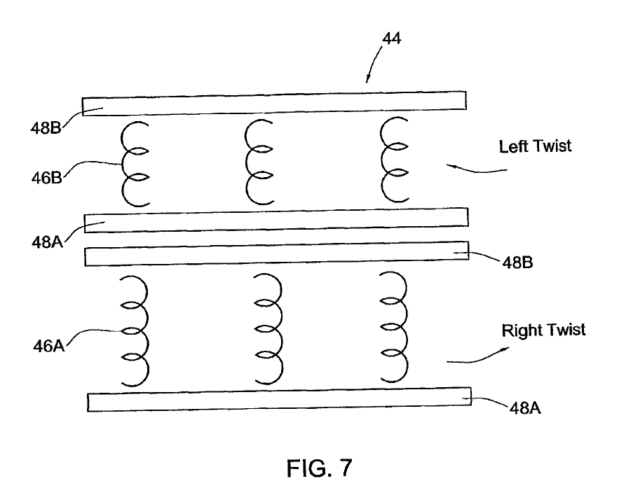

With regard to reflectance, the reflectance of each individual LC layer stacked between two glass or plastic plates is about 200%-25%. To increase the reflectance, a double stack structure of oppositely twisted SSCT material for each color can be used FIG. 7 illustrates an LCD module structure 44 utilizing this effect. The structure contains two spaced-apart parallel layers 46a and 46b of, respectively, right-and left-twisted SSCT. Each of the layers 46a and 46b is enclosed between a pair of transparent (glass or plastic) layers 48a 48b (plates or films).

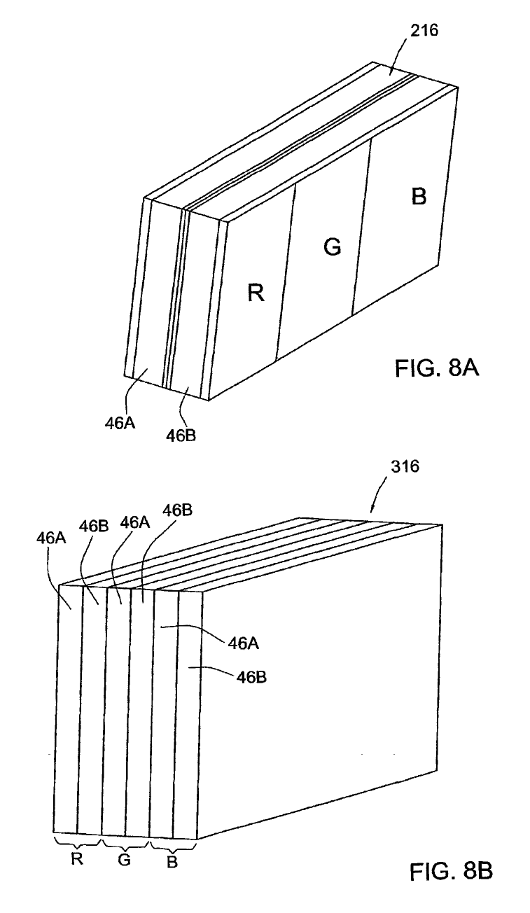

FIGS. 8a and 8b show LCD modules 216 and 316 of two alternating configurations, respectively, namely the color patterning and stacked cell configurations, both utilizing the right- and left-twisted SSCT layers 46a and 46b for each color.

The image contrast is determined as a reflectance ratio between white and black states, i.e., planar and perpendicular states of the LC molecules with respect to the display plane. Experimental results have shown that the contrast value reaches 20:1 for normal viewing, 5:1 for horizontal angular viewing in the range of ±60°, or ranges from +150 to −30° for vertical angular viewing.

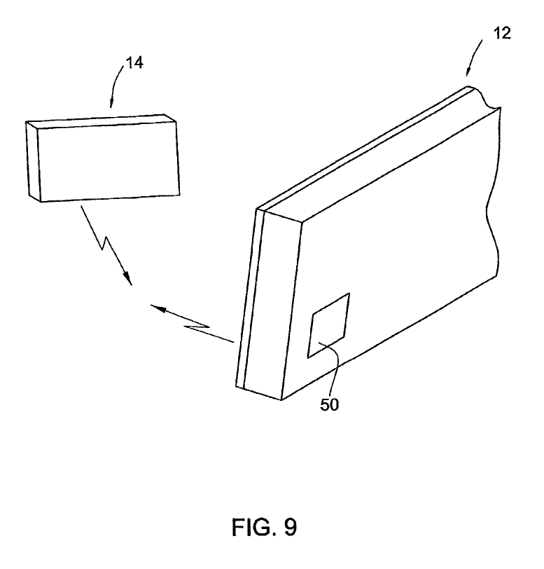

Referring to FIG. 9, the EB 12 is partly illustrated being wireless connected to the remote control unit 14. Such a wireless connection may utilize radio or infrared signal transmission. As shown, the EB 12 is provided with a video camera 50 (constituting a sensor means), installed, for example, at the corner of the billboard. The camera 50 is operated by the control unit 14 for observing the surroundings of the billboard and generating data (images) indicative thereof. This data is transmitted to the control unit through the corresponding utility installed in the electronics-containing layer 30. The control unit 14 (its corresponding utility), upon detecting a predetermined condition in the vicinity of the billboard, operates the billboard for presenting relevant information associated with the detected condition. For example, the camera may capture an image indicative of a traffic jam. The relevant information that can be displayed on the billboard may include a vehicle-related advertisement, e.g., vehicle accessories.

It should be noted that a humidity sensor could be used instead of or in addition to the camera. This sensor may detect the raining condition, in which case the control unit may “decide” to display umbrella-related advertising information. Additionally, a temperature and/or lighting sensor could be used. Such a sensor may detect the sunshine conditions in the vicinity of the display device, and the control unit will immediately operate the display device to advertise sunglasses and/or beverages.

The information to be displayed in response to the detected condition may not interrupt the displaying of the current information (e.g., trains time schedule, etc.). To this end, the control unit may operate one or several locally adjacent LCD modules for displaying the “relevant” information, while presenting the current information on the other LCD modules.

The advantages of the present invention are thus self-evident. The EB has sufficient dimensions and sufficient optical characteristics to be used in public places. The modular structure of the billboard facilitates the operation and maintenance of the billboard. The provision of the temperature sensor and heating/cooling means for each LCD module, enables temperature control and compensation for temperature variations. The provision of the sensor means detecting the conditions in the surroundings of the display panel, enables timely advertisement of the most relevant information. It should also be noted that the provision of a feedback loop between the EB and control unit (which is either integral with the billboard or a stand-alone unit), allows for recording the time schedule of the displayed information. The use of the reflective LCD modules significantly simplifies the construction and operation of the billboard.

Those skilled in the, art will readily appreciate that various modifications and changes may be applied to the preferred embodiments of the invention as hereinbefore exemplified without departing from its scope defined in and by the appended claims.

1. An electronic billboard (EB) system including:
a display device composed of an array of color, reflective, liquid crystal display modules, each including an array of liquid crystals cells, presenting pixels of the display device, and driving circuits selectively operable for displaying a predetermined image by a plurality of said modules;
a sensor means; and
a control unit for operating said driving circuits, the control unit being responsive to data generated by the sensor means for operating the display device accordingly.

2. The system according to claim 1, wherein each of the liquid crystal display modules is provided with cooling and heating means, and the sensor means comprises a temperature sensor, thereby enabling compensation for temperature variations between the modules.

3. The system according to claim 1, wherein the driving circuits comprise an electrical means for applying a certain electric field to the liquid crystal cells to shift them between their inoperative and operative positions.

4. The system according to claim 1, and also including an external illumination system providing desired illumination of the display device.

5. The system according to claim 4, wherein the sensor means comprises an illumination sensor detecting the level of ambient light in the vicinity of the display device, generating data indicative thereof and transmitting said data to the control unit for selectively operating said external illumination system.

6. The system according to claim 1, wherein the sensor means comprises a sensor of a kind capable of determining the existence of certain condition in the vicinity of the display device, generating data indicative thereof and transmitting said data to the control unit.

7. The system according to claim 6, wherein said sensor includes a video camera.

8. The system according to claim 6, wherein said sensor includes a humidity sensor.

9. The system according to claim 6, wherein said sensor includes an acoustic sensor.

10. The system according to claim 1, wherein the control unit is an expert system adapted for artificial intelligence decision making, in response to the data generated by the sensor means.

11. The system according to claim 1, wherein said color reflective LCD modules utilize an LC material type from the following list: Twisted Nematic (TN), Super-Twisted Nematic (STN), Polymer-Dispersed (PDLC), Ferro-Electric, or Cholesteric.

12. The system according to claim 11, wherein the Cholesteric type LC material is Polymer Stabilizes Cholesteric Texture (PSCT).

13. The system according to claim 11, wherein the Cholesteric type LC material is Surface Stabilized Cholesteric Texture (SSCT).

14. The system according to Claim 1, wherein the liquid crystal cells corresponding to different primary colors are aligned in a common plane.

15. The system according to claim 1, wherein the liquid crystal cells corresponding to different primary colors are arranged in a stack.

16. The system according to claim 3, wherein said electrical means are adapted for applying AC bias during the device operation.

17. The system according to claim 1, wherein each liquid crystal cell is subdivided into a plurality of compartments, each presenting a corresponding one of sub-pixels, the driving circuits being adapted for selectively operating said sub-pixels.

18. The system according to claim 17, wherein the sub-pixel subdivision is irregular, thus enabling more uniform color to be obtained across the pixel.

19. The system according to claim 13, wherein each color is formed by two spaced-apart parallel layers of the oppositely twisted SSCT material.

20. The system according to claim 1, wherein said control unit is integral with the display device.

21. The system according to claim 1, wherein said control unit is located remotely from said display device.

22. The system according to claim 1, wherein some utilities of the control unit are integral with the display device, while others are located remotely from the display device.

23. The system according to claim 1, wherein said control unit is capable of creating and storing records indicative of time schedule of displayed information.
